(19) United States
(12) Patent Application Publication
(10) Pub. No.: US 2006/0110559 A1
(43) Pub. Date: May 25, 2006

(54) Crosslinking of carboxylated nitrile polymers with organo functional silanes: a curable plasticizer composition

(76) Inventors: Victor Nasreddine, Sarnia (CA); Sharon X. Guo, Sarnia (CA)

Correspondence Address: LANXESS CORPORATION, 111 RIDC PARK WEST DRIVE, PITTSBURGH, PA, 15275-1112, US

(21) Appl. No.: 11/222,129

(22) Filed: Sep. 8, 2005

Related U.S. Application Data
(60) Provisional application No. 60/616,153, filed on Oct. 5, 2004.

(51) Int. Cl. B60C 1/00; B32B 27/08

(52) U.S. Cl. 428/36.9; 525/329.1; 525/342; 524/494; 428/35.7

(57) ABSTRACT

The present invention relates to a polymer compound containing at least one carboxylated nitrile rubber polymer, that is optionally hydrogenated, at least one organo functional silane compound having at least one epoxy, amine, isocyanate, or any other functional group capable of forming a derivative of a carboxyl group, at least one silane group, and at least one filler, a method of inducing curing in a compound containing at least one carboxylated nitrile rubber polymer, that is optionally hydrogenated, by addition of at least one organo functional silane compound having at least one epoxy, amine, isocyanate, or any other functional group capable of forming a derivative of a carboxyl group, at least one silane group, and at least one filler and subsequent curing.

### FIELD OF THE INVENTION

The present invention relates to a polymer compound containing at least one carboxylated nitrile rubber polymer, that is optionally hydrogenated, at least one organo functional silane compound having at least one epoxy, amine, isocyanate, or any other functional group capable of forming a derivative of a carboxyl group, at least one silane group, and at least one filler, a method of inducing curing in a compound containing at least one carboxylated nitrile rubber polymer, that is optionally hydrogenated, by addition of at least one organo functional silane compound having at least one epoxy, amine, isocyanate, or any other functional group capable of forming a derivative of a carboxyl group, at least one silane group and subsequent curing.

### BACKGROUND OF THE INVENTION

Carboxylated hydrogenated nitrile rubber (HXNBR), prepared by the selective hydrogenation of carboxylated acrylonitrile-butadiene rubber (nitrile rubber; XNBR, a co-polymer comprising at least one conjugated diene, at least one unsaturated nitrile, at least one carboxylated monomer and optionally further comonomers), is a specialty rubber which has very good heat resistance, excellent ozone and chemical resistance, and excellent oil resistance. Coupled with the high level of mechanical properties of the rubber (in particular the high resistance to abrasion) it is not surprising that XNBR and HXNBR have found widespread use in the automotive (belts, seals, hoses, bearing pads) oil (stators, well head seals, valve plates), electrical (cable sheating), mechanical engineering (wheels, rollers), and shipbuilding (pipe seals, couplings) industries, amongst others.

CA 2,462,006 discloses compounds which do not have a silane functionality, and uses epoxy additives having one or more epoxide groups, and at least one crosslinking agent. The present invention has at least one epoxy group and at least one silane functionality, and does not need any additional crosslinking agents. U.S. Pat. No. 6,380,291 discloses a rubber composition comprising an acrylate or methacrylate metal salt, a peroxide-curable elastomer, a plasticizer having one or more epoxide group which displays a lower compound Mooney viscosity and higher delta torque, no other curatives are needed with the present inventive organo functional silane compound, unlike U.S. Pat. No. 6,380,290 which uses an acrylate or methacrylate metal salt with the epoxy additive.

### SUMMARY OF THE INVENTION

In one of it's aspects, the present invention relates to a polymer compound containing at least one carboxylated nitrile polymer, that is optionally hydrogenated, at least one organo functional silane compound having at least one epoxy, amine, isocyanate, or any other functional group capable of forming a derivative of a carboxyl group, at least one silane group, and at least one filler. It is preferred that the XNBR is fully or partially hydrogenated (“HXNBR”). Preferably, the invention relates to a polymer compound comprising at least one carboxylated nitrile polymer, that is optionally hydrogenated, at least one organo functional silane compound having at least one epoxy, amine, isocyanate, or any other functional group capable of forming a derivative of a carboxyl group, at least one silane group, and at least one filler that comprises no further cross-linking agent, such as peroxides, sulphur, sulphur compounds, and the like.

### DESCRIPTION OF THE INVENTION

As used throughout this specification, the term “carboxylated nitrile polymer” or XNBR is intended to have a broad meaning and is meant to encompass an elastomer having repeating units derived from at least one conjugated diene, at least one alpha-beta-unsaturated nitrile, at least one monomer having a carboxylic group and optionally further one or more copolymerizable monomers.

The conjugated diene may be any known conjugated diene, preferably a C₄-C₆ conjugated diene. Preferred conjugated dienes are butadiene, isoprene, piperylene, 2,3-dimethyl butadiene and mixtures thereof. Even more preferred C₄-C₆ conjugated dienes are butadiene, isoprene and mixtures thereof. The most preferred C₄-C₆ conjugated diene is butadiene.

The alpha-beta-unsaturated nitrile may be any known alpha-beta-unsaturated nitrile, preferably a C₃-C₅ alpha-beta-unsaturated nitrile. Preferred C₃-C₅ alpha-beta-unsaturated nitriles are acrylonitrile, methacrylonitrile, ethacrylonitrile and mixtures thereof. The most preferred C₃-C₅ alpha-beta-unsaturated nitrile is acrylonitrile.

The monomer having at least one carboxylic group may be any known monomer having at least one carboxylic group being copolymerizable with the nitrile and the diene.

Preferred monomers having at least one carboxylic group are unsaturated carboxylic acids. Non-limiting examples of suitable unsaturated carboxylic acids are fumaric acid, maleic acid, acrylic acid, methacrylic acid and mixtures thereof.

Preferably, the copolymer contains in the range of from 40 to 85 weight percent of repeating units derived from one or more conjugated dienes, in the range of from 15 to 60 weight percent of repeating units derived from one or more unsaturated nitriles and in the range of from 0.1 to 15 weight percent of repeating units derived from one or more monomers having at least one carboxylic group. More preferably, the copolymer contains in the range of from 55 to 75 weight percent of repeating units derived from one or more conjugated dienes, in the range of from 25 to 40 weight percent of repeating units derived from one or more unsaturated nitrites and in the range of from 1 to 7 weight percent of repeating units derived from one or more monomers having at least one carboxylic group.

Optionally, the copolymer may further contain repeating units derived from one or more copolymerizable monomers, such as alkylacrylate, styrene. Repeating units derived from one or more copolymerizable monomers will replace either the nitrile or the diene portion of the nitrile rubber and it will be apparent to the skilled in the art that the above mentioned figures will have to be adjusted to result in 100 weight percent.

Hydrogenated in this invention is preferably understood by more than 50% of the residual double bonds (RDB) present in the starting nitrile polymer/NBR being hydrogenated, preferably more than 90% of the RDB are hydrogenated, more preferably more than 95% of the RDB are hydrogenated and most preferably more than 99% of the RDB are hydrogenated.

The present invention is not restricted to a special process for preparing the hydrogenated carboxylated NBR. However, the HXNBR preferred in this invention is readily available as disclosed in WO-01/77185-A1. For jurisdictions allowing for this procedure, WO-1/77185-A1 is incorporated herein by reference.

The XNBR as well as the HXNBR which forms a preferred component of the polymer compound of the invention can be characterized by standard techniques known in the art. For example, the molecular weight distribution of the polymer was determined by gel permeation chromatography (GPC) using a Waters 2690 Separation Module and a Waters 410 Differential Refractometer running Waters Millennium software version 3.05.01. Samples were dissolved in tetrahydrofuran (THF) stabilized with 0.025% BHT. The columns used for the determination were three sequential mixed-B gel columns from Polymer Labs. Reference Standards used were polystyrene standards from American Polymer Standards Corp.

The present inventive polymer compound further contains at least one organo functional silane compound having at least one epoxy, amine, isocyanate, or any other functional group capable of forming a derivative of a carboxyl group, and at least one silane group. In this invention, the organo functional silane has a general formula Xₐ—R′—[Si—(OR″)_{b}]_{c} where X is an epoxy, amine, isocyanate, or any other functional group capable of forming a derivative of a carboxyl group and a is equal to one or greater; R′ is an alkylene group; OR″ is an alkoxy or acyloxy group; b=1, 2, or 3; c is equal to one or greater. This additive acts as a curable (reactive) plasticizer which cures the said carboxylated nitrile polymer (as seen in MDR), increases its modulus, and improves the processibility by lowering the Mooney viscosity. Moreover, it is the only curative used with no need for other traditional curatives such as sulphur or peroxide.

Another aspect of the polymer compound of this invention is that it will have improved sealing performance since minimal plasticizer is needed in the compound.

The inventive polymer compound further contains at least one filler. The filler may be an active or an inactive filler or a mixture thereof. The filler may be in particular
highly dispersed silicas, prepared e.g. by the precipitation of silicate solutions or the flame hydrolysis of silicon halides, with specific surface areas of in the range of from 5 to 1000 m²/g, and with primary particle sizes of in the range of from 10 to 400 nm; the silicas can optionally also be present as mixed oxides with other metal oxides such as those of Al, Mg, Ca, Ba, Zn, Zr and Ti;
synthetic silicates, such as aluminum silicate and alkaline earth metal silicate like magnesium silicate or calcium silicate, with BET specific surface areas in the range of from 20 to 400 m²/g and primary particle diameters in the range of from 10 to 400 nm;
natural silicates, such as kaolin and other naturally occurring silica;
glass fibers and glass fiber products (matting, extrudates) or glass microspheres;
carbon blacks; the carbon blacks to be used here are prepared by the lamp black, furnace black or gas black process and have preferably BET (DIN 66 131) specific surface areas in the range of from 20 to 200 m²/g, e.g. SAF, ISAF, HAF, FEF or GPF carbon blacks;
rubber gels, especially those based on polybutadiene, butadiene/styrene copolymers, butadiene/acrylonitrile copolymers and polychloroprene;

or mixtures thereof.

Examples of preferred mineral fillers include silica, silicates, clay such as bentonite, gypsum, alumina, titanium dioxide, talc, mixtures of these, and the like. These mineral particles have hydroxyl groups on their surface, rendering them hydrophilic and oleophobic. This exacerbates the difficulty of achieving good interaction between the filler particles and the rubber. For many purposes, the preferred mineral is silica, especially silica made by carbon dioxide precipitation of sodium silicate. Dried amorphous silica particles suitable for use in accordance with the invention may have a mean agglomerate particle size in the range of from 1 to 100 microns, preferably between 10 and 50 microns and most preferably between 10 and 25 microns. It is preferred that less than 10 percent by volume of the agglomerate particles are below 5 microns or over 50 microns in size. A suitable amorphous dried silica moreover usually has a BET surface area, measured in accordance with DIN (Deutsche Industrie Norm) 66131, of in the range of from 50 and 450 square meters per gram and a DBP absorption, as measured in accordance with DIN 53601, of in the range of from 150 and 400 grams per 100 grams of silica, and a drying loss, as measured according to DIN ISO 787/11, of in the range of from 0 to 10 percent by weight. Suitable silica fillers are available under the trademarks HiSil® 210, HiSil® 233 and HiSil® 243 from PPG Industries Inc. Also suitable are Vulkasil S and Vulkasil N, from LANXESS AG.

Often, use of carbon black as a filler is advantageous. Usually, carbon black is present in the polymer composite in an amount of in the range of from 20 to 200 parts by weight, preferably 30 to 150 parts by weight, more preferably 40 to 100 parts by weight. Further, it might be advantageous to use a combination of carbon black and mineral filler in the inventive polymer composite. In this combination the ratio of mineral fillers to carbon black is usually in the range of from 0.05 to 20, preferably 0.1 to 10.

The rubber composition according to the present invention can contain further auxiliary products for rubbers, such as reaction accelerators, vulcanizing accelerators, vulcanizing acceleration auxiliaries, antioxidants, foaming agents, anti-aging agents, heat stabilizers, light stabilizers, ozone stabilizers, processing aids, plasticizers, tackifiers, blowing agents, dyestuffs, pigments, waxes, extenders, organic acids, inhibitors, metal oxides, and activators such as triethanolamine, polyethylene glycol, hexanetriol, etc., which are known to the rubber industry. The rubber aids are used in conventional amounts, which depend inter alia on the intended use. Conventional amounts are e.g. from 0.1 to 50 wt. %, based on rubber. Preferably the composition comprises in the range of 0.1 to 20 phr of an organic fatty acid as an auxiliary product, preferably a unsaturated fatty acid having one, two or more carbon double bonds in the molecule which more preferably includes 10% by weight or more of a conjugated diene acid having at least one conjugated carbon-carbon double bond in its molecule. Preferably those fatty acids have in the range of from 8-22 carbon atoms, more preferably 12-18. Examples include stearic acid, palmitic acid and oleic acid and their calcium-, zinc-, magnesium-, potassium- and ammonium salts. Preferably the composition comprises in the range of 5 to 50 phr of an acrylate as an auxiliary product. Suitable acrylates are known from EP-A1-0 319 320, in particular p. 3, I. 16 to 35, from U.S. Pat. No. 5,208,294, in particular Col. 2, I. 25 to 40, and from U.S. Pat No. 4,983,678, in particular Col. 2, I. 45 to 62. Particular reference is made to zinc acrylate, zinc diacrylate or zinc dimethacrylate or a liquid acrylate, such as trimethylol-propanetrimethacrylate (TRIM), butanedioldimethacrylate (BDMA) and ethylenglycoldimethacrylate (EDMA). It might be advantageous to use a combination of different acrylates and/or metal salts thereof. Of particular advantage is often to use metal acrylates in combination with a Scorch-retarder such as sterically hindered phenols (e.g., methyl-substituted aminoalkylphenols, in particular 2,6-di-tert.-butyl-4-dimethylamino-methylphenol).

The ingredients of the final polymer composite are mixed together, suitably at an elevated temperature that may range from 25° C. to 200° C. Normally the mixing time does not exceed one hour and a time in the range from 2 to 30 minutes is usually adequate. The mixing is suitably carried out in an internal mixer such as a Banbury mixer, or a Haake or Brabender miniature internal mixer. A two-roll mill mixer also provides a good dispersion of the additives within the elastomer. An extruder also provides good mixing, and permits shorter mixing times. It is possible to carry out the mixing in two or more stages, and the mixing can be done in different apparatus, for example one stage in an internal mixer and one stage in an extruder. For compounding and vulcanization see also: Encyclopedia of Polymer Science and Engineering, Vol. 4, p. 66 et seq. (Compounding) and Vol. 17, p. 666 et seq. (Vulcanization).

Thus, the present invention provides a composition containing at least one carboxylated nitrile rubber polymer, that is optionally hydrogenated, at least one organo functional silane compound having at least one epoxy, amine, isocyanate, or any other functional group capable of forming a derivative of a carboxyl group, at least one silane group, and at least one filler. Furthermore, the inventive polymer compound may be used in the manufacture of a shaped article containing said inventive polymer compound. Preferred shaped articles are a timing belt, seal, hose, bearing pad, stator, well head seal, valve plate, cable sheating, wheel roller, pipe seal, in place gaskets or footwear component prepared by injection molding technology. Furthermore, the inventive polymer composite is very well suited for wire and cable production.

The invention is further illustrated but is not intended to be limited by the following examples in which all parts and percentages are by weight unless otherwise specified.

### EXAMPLES

### Examples 1-3

Polymer composites were mixed in a brabender miniature internal mixer in a single mixing step (8 min/30° C./80 rpm). Composites can also be prepared by mill mixing. The formulations used in this assessment are based on a recipe according to Table 1. Example 3 is comparative.

TABLE 1
Compounding Recipe.

| | Example 1 | Example 2 | Comp. 3 |
|---|---|---|---|
| ARMEEN 18D | 0.5 | 0.5 | 0.5 |
| THERBAN XT 8889 | 100 | 100 | 100 |
| CARBON BLACK, N 660 | 50 | 50 | 50 |
| STERLING-V | | | |
| NAUGARD 445 | 1 | 1 | 1 |
| PLASTHALL TOTM | 5 | 5 | 5 |
| DIAK #7 | | | 1.5 |
| DOW CORNING Z-6040 | 5 | 10 | |
| STRUKTOL ZP 1014 | | | 7 |
| VULCUP 40KE | | | 7 |

Armeen™ 18D is an octadecylamine available from AkzoNobel and is used to reduce compound stickiness to metal.
THERBAN™ XT™ 8889 is HXNBR from LANXESS AG.
Naugard™ 445 (p-dicumyl diphenyl amine) is a stabilizer from Uniroyal.
Plasthall TOTM™ (Trioctyl Trimellitate) is a plasticizer from C.P. Hall.
Diak™ 7 (Triallyl isocyanurate) is a coagent from DuPont.
Struktol™ ZP 1014 (zinc peroxide 50% on inert carrier).
Vulcup 40 KE (α,α-bis(t-butylperoxy)diisopropylbenzene), 40% peroxide.
The organofunctional silane compound used as a curable plasticizer agent is DOW CORNING Z-6040™ (3-glycidoxypropyltrimethoxysilane) a liquid additive and is available from the Dow Coming Corporation.

### Polymer Composites Properties

Table 2 shows a summary of the properties of polymer composites of Exp. 1-3. MDR Cure Properties (ASTM D5289, 180° C., 1° arc, 1.7 Hz, 60 minutes), Mooney (ASTM D1646), and Stress-Strain (ASTM D412).

TABLE 2
Polymer Composite properties.

| | Example 1 | Example 2 | Comp. 3 |
|---|---|---|---|
| MDR Cure Properties | | | |
| Maximum Torque (MH, Dn · m) | 21.14 | 36.83 | 41.46 |
| Minimum Torque (ML, Dn · m) | 1.59 | 1.45 | 1.80 |
| Delta MH-ML (Dn · m) | 19.55 | 35.38 | 39.66 |
| t 90 (min) | 36.5 | 40.7 | 12.4 |
| Mooney | | | |
| ML (1 + 4) @ 100 C. | 82 | 70 | 78 |
| Stress-Strain | | | |
| Hardness (Shore A) | 62 | 69 | 71 |
| Elongation @ Break (%) | 475 | 194 | 195 |
| Ultimate Tensile (MPa) | 13.4 | 14.0 | 26.2 |
| Modulus @ 100% (MPa) | 3.0 | 6.9 | 12.5 |

The Delta MH-ML gives an indication of the crosslinking density. In the absent of any conventional curatives, examples 1 and 2 showed a delta torque of 19.5 to 35.5. The delta torque increases as a function of DOW CORNING Z-6040™ content as well as the Modulus at 100%. A 10 phr of DOW CORNING Z-6040™ gives a cure density close to 7 phr of Vulcup 40KE (peroxide). Moreover, the Mooney viscosity decreases as a function of glycidoxy functional silane compound content. The increasing delta torque and decreasing Mooney viscosity is evidence that this additive is behaving as a curative for HXNBR as well as a plasticizer.

1-11. (canceled)

12. A curable polymer compound comprising at least one, optionally hydrogenated carboxylated nitrile polymer, at least one organo functional silane compound having at least one epoxy, amine, isocyanate, or any other functional group capable of forming a derivative of a carboxyl group and at least one filler.

13. The curable polymer compound according to claim 12, wherein the silane compound is of the formula Xₐ—R′—[Si—(OR″)_{b}]_{c}
wherein X is an epoxy, amine, isocyanate, or any other functional group capable of forming a derivative of a carboxyl group,
a is a numeral greater than or equal to 1,
R′ is an alkylene group,
OR″ is an alkoxy or acyloxy group,
b is a numeral selected from 1, 2, or 3, and
c is a numeral greater than or equal to 1.

14. The curable polymer compound according to claim 12, wherein the carboxylated nitrile polymer is a hydrogenated carboxylated nitrile rubber.

15. The curable polymer compound according to claim 12, wherein the compound does not comprise any further cross-linking or curing agent.

16. The curable polymer compound according to claim 15, wherein the compound does not comprise a curative selected from an acrylate or a methacrylate metal salt having an epoxy additive.

17. The curable polymer compound according to claim 12, wherein the organo functional silane compound is 3-glycidoxypropyltrimethoxysilane.

18. The curable polymer compound according to claim 12, wherein the functional silane compound is present in an amount of from 1 to 20 phr.

19. The curable polymer compound according to claim 18, wherein the functional silane compound is present in an amount of from 5 to 10 phr.

20. A process of curing a compound comprising admixing at least one, optionally hydrogenated, carboxylated nitrile rubber polymer with at least one organo functional silane compound having at least one epoxy, amine, isocyanate, or any other functional group capable of forming a derivative of a carboxyl group.

21. A shaped article comprising a cured polymer compound according to claim 12.

22. A shaped article according to claim 21 in the form of a of a seal, hose, bearing pad, stator, well head seal, valve plate, cable sheeting, wheel roller, pipe seal, belt, in place gaskets or footwear component prepared by injection molding technology, wire and cable production.

23. A shaped article according to claim 21, wherein to shaped article Is a timing or conveyor belt.

24. A method for improving the dispersion of mineral fillers and glass fibers in a compound comprising admixing at least one, optionally hydrogenated, carboxylated nitrile rubber polymer with at least one organo functional silane compound having at least one epoxy, amine, isocyanate, or any other functional group capable of forming a derivative of a carboxyl group.

25. A method of improving adhesion to a substrate comprising applying to a substrate a compound comprising at least one, optionally hydrogenated carboxylated nitrile polymer, at least one organo functional silane compound having at least one epoxy, amine, isocyanate, or any other functional group capable of forming a derivative of a carboxyl group and at least one filler.
